(19) United States
(12) Patent Application Publication
(10) Pub. No.: US 2016/0167011 A1
(43) Pub. Date: Jun. 16, 2016

(54) METHOD FOR PRODUCING A GRAPHENE

(71) Applicant: Chung Yuan Christian University, Taoyuan City (TW)

(72) Inventors: Wei-Jen Liu, Taoyuan City (TW); Kuei-Ting Hsu, Taoyuan City (TW); Pin-Chun Lin, Zhubei City (TW)

(21) Appl. No.: 14/791,968

(22) Filed: Jul. 6, 2015

(30) Foreign Application Priority Data
Dec. 11, 2014 (TW) 103143267

(51) Int. Cl. B01J 19/10; C01B 31/04

(52) U.S. Cl. CPC B01J 19/10; C01B 31/0446

(57) ABSTRACT

The present invention is disclosed a method for producing a graphene, comprising: Providing a carbon material; processing a rolling procedure; processing a ultrasound procedure; and obtaining a solution containing a graphene, wherein the solution containing the graphene is obtaining from a upper liquid of a solution processing a ultrasound procedure. The present invention provides the ability for reducing the manufacturing cost of graphene, reducing the environmental pollution, and increasing the graphene yield.

### FIELD OF THE INVENTION

The present invention relates to a method for producing a graphene, particularly, relates to a method for producing a high yield of graphene from carbon material.

### BACKGROUND OF THE INVENTION

There are many methods for producing a graphene, such as mechanical exfoliation, chemical vapor deposition, epitaxial growth, and oxidation reduction, and so on.

Mechanical exfoliation is a method exfoliates graphene mechanically to obtain sheets of graphene. However, the yield of graphene by mechanical exfoliation is too low to make the mechanical exfoliation being used in mass production.

The chemical vapor deposition method or epitaxial growth method is by passing gas source containing hydrocarbon compounds of pyrolysis and depositing it on a nickel sheet or a copper sheet to produce large-area, single-layer or multi-layer graphene. However, the homogeneousness and thickness of graphene is difficult to control these methods. Moreover, the graphene grown on an insulator substrate, such as a film of graphene grown on the surface of silicon carbide, has the drawbacks of high costs and difficulty in large-area production.

By oxidation reduction method, functional graphite oxides are made by chemical exfoliation of treating graphite powder or graphite fiber with strong oxidants of sulphuric acid or nitric acid or ones of other oxidization treatment. Graphite oxides complex is put into a muffle furnace at temperature of 1100° C. to 1250° C. to be dilated and exfoliated. although the graphene oxide may be formed by exfoliating graphite oxide, the electrical conductivity of graphite oxide is much lower than one of graphene because the electrical and physical structures of graphene are influenced by harmful condition. Moreover, method processes a long-time treatment which causes graphene in uneven quality, and the graphene, reduced from the graphene oxide is easy to deform and warp. Besides, waste acids generated in a process of oxidation reduction also results in environment pollution.

There are other methods. For example, graphene is obtained by reducing graphene oxide with hydrazide or other organic substances, or by reducing graphene oxide with heat treatment at temperature of 1050° C. However, these methods need high-cost equipments and result in issues on environment protection, as well as produce low-yield of graphene.

TW201326036 and TW201311553 disclose the methods for graphene formation and manufacture, and both of them form graphene by oxidation reduction.

US20090226684A1 discloses a third embodiment that obtains carbon nanotubes of particle size smaller than 3 um by oxidation pretreatment on carbon nanotubes followed by ultrasound and high-pressure homogenizer treatments. Such a method not only needs oxidation pretreatment but also only obtain carbon nanotubes of particle size smaller than 3 um.

Accordingly, these issues, including how to reduce the manufacturing cost of graphene, reduce the fundamental cost of graphene, simplify the manufacturing method of graphene, as well as enhance the yield of graphene and reduce the particle sizes of graphene products at same time, are concerned by relevant fields to resolve them.

### SUMMARY OF THE INVENTION

Accordingly, the present invention provides a method for producing graphene in enhanced yield.

Accordingly, the present invention provides a method for producing graphene in a simple and low-cost way.

Accordingly, the present invention provides a method for producing graphene of low pollution.

Accordingly, The present invention provides a method for producing graphene in sizes of 30-50 nm.

Accordingly, a method for producing graphene, comprises: providing a carbon material; processing a rolling procedure, the rolling procedure comprising: pressing the carbon material to disperse and crush the carbon material into a smashed carbon material; and forming a first solution by mixing the smashed carbon material and a solvent; processing a ultrasound procedure, the ultrasound procedure comprising: ultrasonicating the first solution; and obtaining a second solution after ultrasonication; and obtaining a solution containing the graphene from an upper liquid of the second solution after ultrasonication.

A method for producing graphene, comprises: providing a carbon material; processing a rolling procedure, the rolling procedure comprising: pressing the carbon material to disperse and crush the carbon material into a smashed carbon material; and forming a first solution by mixing the smashed carbon material and a solvent; processing a homogenization procedure to homogenously disperse the smashed carbon material in the first solution; processing a ultrasound procedure, the ultrasound procedure comprising: ultrasonicating the first solution; and obtaining a second solution from the first solution after ultrasonication; and obtaining a solution containing the graphene from an upper liquid of the second solution after ultrasonication.

The present invention has advantages as follows: 1. Enhancement on graphene yield; 2. the method for producing graphene in simple ways and low costs; 3. Low pollution; and 4. Graphene at sizes of 30-50 nm.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a flow chart illustrating the method for producing graphene of the first embodiment in the present invention.

FIG. 2 is a flow chart illustrating the method for producing graphene of the second embodiment in the present invention.

FIG. 3 is a flow chart illustrating the method for producing graphene of the third embodiment in the present invention.

FIG. 4 is an electron microscope illustrating an exemplary embodiment after a rolling procedure in the present invention.

FIG. 5 is an electron microscope illustrating an exemplary embodiment after homogenization in the present invention.

FIG. 6 is an electron microscope illustrating an exemplary embodiment after an ultrasound procedure in the present invention.

FIG. 7 is a photo of graphene solution according to an embodiment of the present invention.

### DETAILED DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

A method for producing graphene is provided to include the steps as follows: providing a carbon material; processing a rolling procedure; processing a ultrasound procedure; and obtaining a solution containing the graphene. The solution containing the graphene is obtained from an upper liquid of a solution after ultrasonication. In the present invention provides the enhancement of graphene yield and meanwhile simplifies the manufacturing process and reduces the cost of graphene.

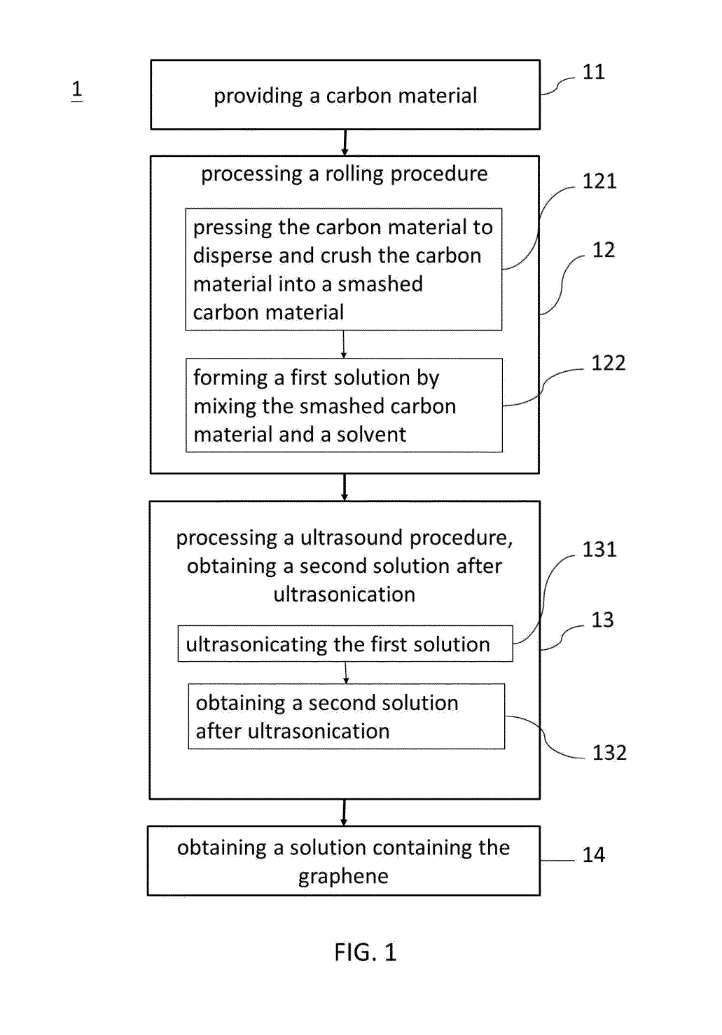

FIG. 1 is an exemplary flow chart illustrating a first method for producing graphene 1 of the present invention. Please refer to FIG. 1, the first method includes steps 11-14 as follows.

Step 11: a carbon material is provided herein. The carbon material may be one of single-wall carbon nanotubes, multi-wall carbon nanotubes, other type carbon material, and the combination thereof.

Step 12: a rolling procedure is proceeded to disperse, crush or broke the carbon material. The rolling procedure includes steps 121 and 122. Step 121: a pressure treatment is applied on the carbon material to disperse and crush the carbon material into a smashed carbon material. The exemplary pressure is larger than 100 kg f/cm², and from 100 kg f/cm² to 700 kg f/cm² is preferred. The duration of the pressure on the carbon material is from 1 second to 100 hours, and from 1 second to 10 minutes being preferred. Step 122: a first solution is formed by mixing the smashed carbon material and a solvent. The exemplary solvent may be deionized water (DI water), ethanol, Methylpyrrolidone (NMP) or isopropyl alcohol.

Step 13: an ultrasound procedure is proceeded. The ultrasound procedure is a physical method to make the smashed carbon material into a solution containing graphene. An ultrasonic homogenizer is used for ultrasonication in the steps 131 and 132 of the ultrasound procedure. Step 131: the first solution is ultrasonicated at duration of 1 second to 100 hours. In the first embodiment, the ultrasonicating time from 1 to 10 minutes is preferred. The ultrasonicating power is larger than 80 watts and preferred from 100 watts to 1500 watts. Step 132: a second solution is obtained from the first solution after ultrasonication.

Step 14: a solution containing graphene is obtained. Graphene suspends within an upper liquid of the second solution from step 132 and is extracted in step 14. The size of the graphene in the present invention may be from 30 to 50 nm.

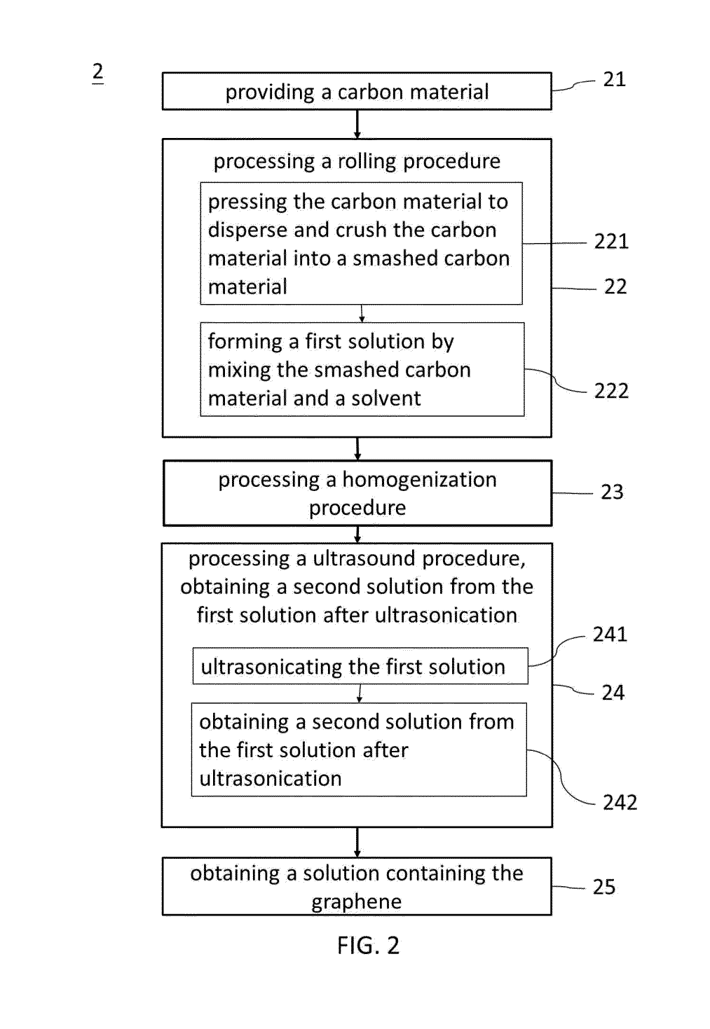

Besides, in the present invention, a homogenization procedure may be added between the rolling procedure and the ultrasound procedure for the improvement on the yield of graphene. FIG. 2 is an exemplary flow chart illustrating a second method for producing graphene 2 of the present invention. The second method 2 includes steps 21-25.

It is understood that steps 21, 22, 24, 25, 221, 222, 241 and 242 in the second embodiment is similar to ones in the first embodiment, and they will not be illustrated in the following paragraphs. For the purpose of making the smashed carbon material homogenously disperse within the first solution, the homogenization procedure may be proceeded after the formation of the first solution.

The homogenization procedure includes a blending treatment with one or more beads in a homogenous blender. The materials of the beads may be one of zirconium oxide, aluminium oxide, agate, stainless steel, and silicon carbide. However, other general types of beads may be used, but not to limit ones aforementioned.

Alternatively, the homogenous blender in the second embodiment may be replaced by a ball grinder. Alternatively, the homogenization procedure may use the ball grinder after the usage of the homogenous blender, such that the carbon material may be crushed completely and dispersed homogenously within the first solution.

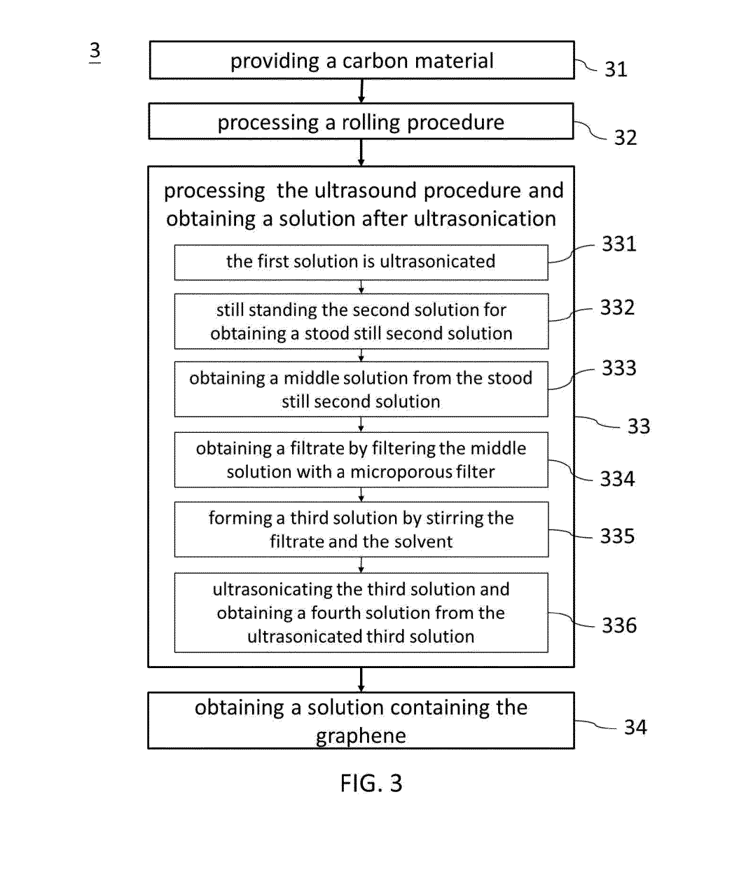

FIG. 3 an exemplary flow chart illustrating a third method for producing graphene 3 of the present invention. The third embodiment includes an ultrasound procedure. The steps 31, 32, and 34 in the third embodiment are same as one in the first embodiment, and will not be repeated. Another implement of the ultrasound procedure is illustrated in step 33.

Step 33 proceeds after the formation of the first solution, and includes processing the ultrasound procedure and obtaining a solution after ultrasonication. The details include steps 331-336.

Step 331: the first solution is ultrasonicated at duration of 1 second to 100 hours, and the ultrasonicating time of 1 second to 10 minutes is preferred.

Step 332: a second solution from the first solution after ultrasonication stands still at duration of 1 minute to 30 minutes, and the best duration of still standing is from 5 minutes to 10 minutes. At the moment, the hazy second solution is gradually converted into supernatant coming with the formation of precipitate or sediment in a beaker. The smashed carbon material having greater volumes will become precipitate. A gradient of the smashed carbon material after stood still is distributed down from the mouth of the beaker in the second solution.

Step 333: a middle solution is obtained from the stood still second solution and a filtrate is obtained from the middle solution with a microporous filter. In the embodiment, the middle solution includes the most volume of graphene product.

Step 334: a third solution is formed by mixing the filtrate and a solvent, and the solvent may be one of deionized water, ethanol, Methylpyrrolidone (NMP) and isopropyl alcohol.

Step 335: the third solution is ultrasonicated and a fourth solution is obtained from the ultrasonicated third solution. The third solution is ultrasonicated at duration of 1 second to 100 hours, and the duration of 1 minute to 10 minutes is preferred. The ultrasonicating power is larger than 80 watts, and the preferred level of the ultrasonicating power is from 100 watts to 1500 watts.

Step 336: the ultrasonicated solution is obtained followed by proceeding step 34 of obtaining a solution obtaining graphene.

### Exemplary Embodiments

The materials used in the embodiments of the present invention are as follows: the carbon material is carbon nanotubes, the solvent is Methylpyrrolidone, and the steps are rolling procedure, homogenization, and ultrasound procedure in sequence.

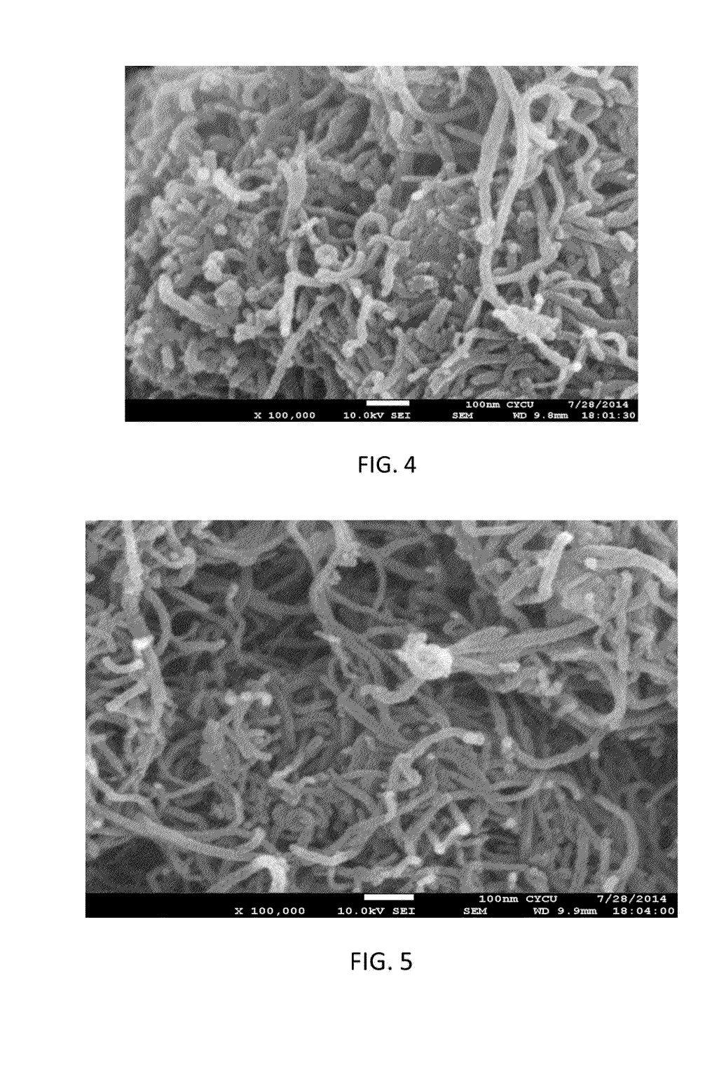

First, the carbon material is pressed at the pressure of 630 kg f/cm² for 15 minutes in the rolling procedure. The electron microscope of the carbon material after rolling procedure is shown in FIG. 4. Please refer to FIG. 4, the structures of the carbon nanotubes can be seen clearly, and the smashed carbon material is shown as fragments with different sizes.

Next, a homogenization procedure is proceeded. One or more zirconia balls, the smashed carbon material and the solvent of Methylpyrrolidone are added into a homogenous blender and mixed at the rotation rate of the homogenous blender of 500 rpm for 3 hours. One electron microscope is in FIG. 5 to show the structures of the carbon material are more crushed and dispersed after the homogenization procedure.

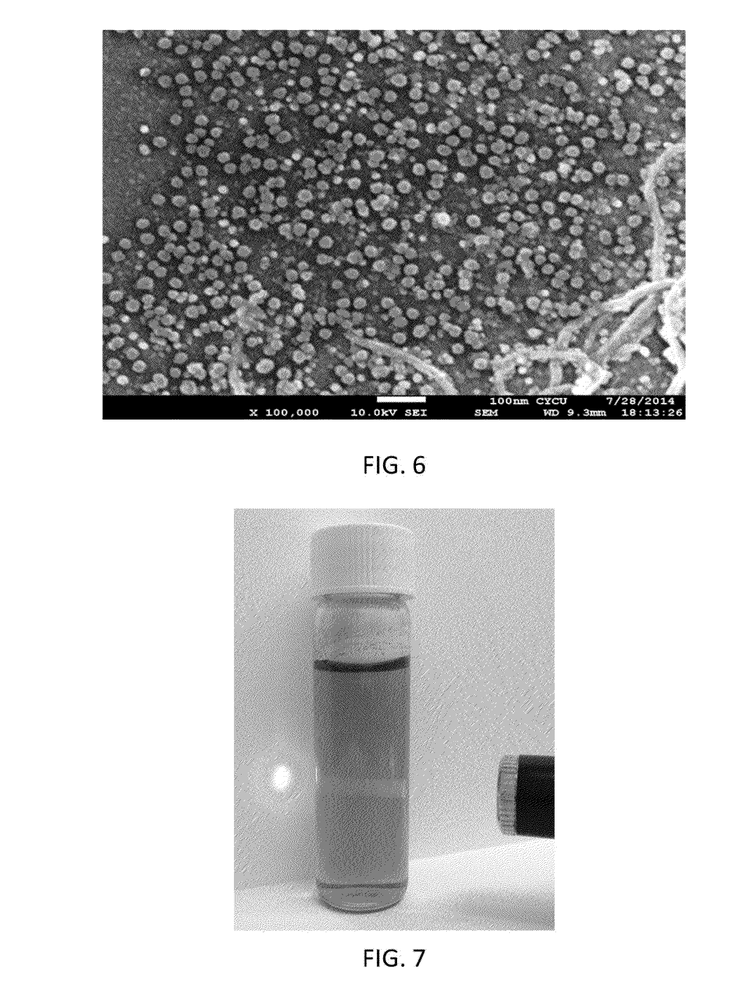

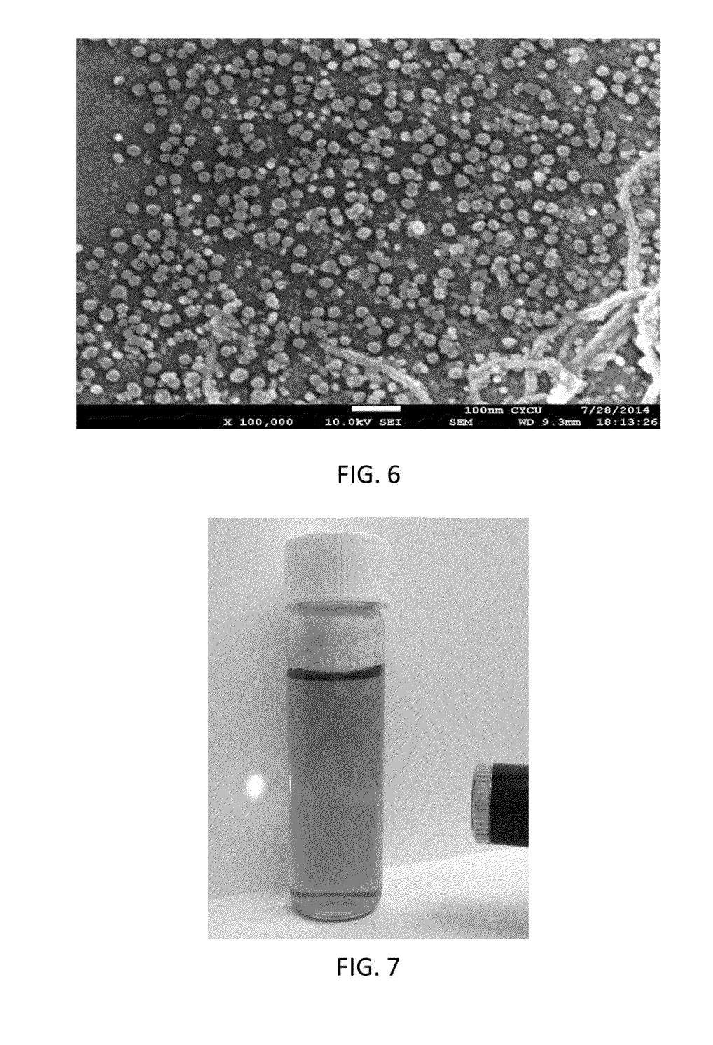

Next, a ultrasound procedure is proceed at the power of 1200 watts for 15 minutes to obtain the solution containing graphene at sizes of 30 nm to 50 nm. One electron microscope of graphene after the ultrasound procedure is shown in FIG. 6 to represent the sheets of graphene at sizes of 30 nm to 50 nm.

Furthermore, a photo of graphene solution after the ultrasound procedure (such as step 242) is shown in FIG. 7. The upper solution is the solution containing graphene (step 25). A proof of Tyndall effect by radiating with a laser pen shows particles of nano sizes exist in the upper solution.

In general, the methods in the present invention do not need regular chemical methods such as chemical vapor deposition and chemical exfoliation to produce graphene. High cost of chemical vapor deposition is not suitable for mass production. Chemical exfoliation, which produces graphene by oxidation with strong acid and oxidant, intercalation for graphite oxide and delamination with high temperature and ultrasonic treatments, can be used in mass production and reduce costs. However, the usage of huge volume of acids and oxidants in chemical exfoliation results in environment pollution. Besides, graphene produced by chemical exfoliation has a drawback of structure defects that influences electronic and thermal conductivities of graphene. Compared with the regular chemical methods, the methods for producing graphene 1, 2 and 3 in the present invention do not use strong acids and strong oxidants, which have features of environment protection, low pollution, high yield, low cost, and simply steps. By the methods in the present invention, nano graphene material in high quality, low defects, and high electrical conductivity can be in mass production.

Accordingly, the present invention has advantages as follows: 1. Enhancement on graphene yield; 2. the method for producing graphene in simple ways and low costs; 3. Low pollution; and 4. Graphene at sizes of 30-50 nm.

Although specific embodiments have been illustrated and described, it will be appreciated by those skilled in the art that various modifications may be made without departing from the scope of the present invention, which is intended to be limited solely by the appended claims.

What is claimed is:

1. A method for producing graphene, comprising:
providing a carbon material;
processing a rolling procedure, the rolling procedure comprising: pressing the carbon material to disperse and crush the carbon material into a smashed carbon material; and forming a first solution by mixing the smashed carbon material and a solvent;
processing a ultrasound procedure, the ultrasound procedure comprising: ultrasonicating the first solution; and obtaining a second solution after ultrasonication; and
obtaining a solution containing the graphene from an upper liquid of the second solution after ultrasonication.

2. The method for producing graphene of claim 1, wherein the step of processing the ultrasound procedure further comprising: still standing the second solution for obtaining a stood still second solution; obtaining a middle solution from the stood still second solution and obtaining a filtrate by filtering the middle solution with a microporous filter; forming a third solution by stirring the filtrate and the solvent; and ultrasonicating the third solution and obtaining a fourth solution from the ultrasonicated third solution.

3. The method for producing graphene of claim 1, wherein the carbon material comprising at least one of single-wall carbon nanotubes and multi-wall carbon nanotubes.

4. The method for producing graphene of claim 1, wherein a pressure in the pressing step is from 100 kg f/cm² to 700 kg f/cm².

5. The method for producing graphene of claim 1, wherein the carbon material is pressed for from 1 second to 100 hours.

6. The method for producing graphene of claim 1, wherein the solvent comprising one of deionized water, ethanol, Methylpyrrolidone (NMP) and isopropyl alcohol.

7. The method for producing graphene of claim 1, wherein the ultrasonicating power is from 100 watts to 1500 watts.

8. The method for producing graphene of claim 1, wherein the ultrasonicating time is from 1 second to 100 hours.

9. A method for producing graphene, comprising providing a carbon material;
processing a rolling procedure, the rolling procedure comprising: pressing the carbon material to disperse and crush the carbon material into a smashed carbon material; and forming a first solution by mixing the smashed carbon material and a solvent;
processing a homogenization procedure to homogenously disperse the smashed carbon material in the first solution;
processing a ultrasound procedure, the ultrasound procedure comprising: ultrasonicating the first solution; and obtaining a second solution from the first solution after ultrasonication; and
obtaining a solution containing the graphene from a upper liquid of the second solution after ultrasonication.

10. The method for producing graphene of claim 9, wherein the step of processing the homogenization procedure comprising a blending treatment which blending the carbon material by a homogenous blender.

11. The method for producing graphene of claim 10, wherein the step of processing the homogenization procedure further comprising adding a bead in the blending treatment.

12. The method for producing graphene of claim 10, wherein a rotation rate of the homogenous blender is from 100 rpm to 3000 rpm.

13. The method for producing graphene of claim 9, wherein the step of processing the ultrasound procedure further comprising: still standing the second solution for obtaining a stood still second solution; obtaining a middle solution from the stood still second solution and obtaining a filtrate by filtering the middle solution with a microporous filter; forming a third solution by stirring the filtrate and the solvent; and ultrasonicating the third solution and obtaining a fourth solution from the ultrasonicated third solution.

14. The method for producing graphene of claim 9, wherein the carbon material comprising at least one of single-wall carbon nanotubes and multi-wall carbon nanotubes.

15. The method for producing graphene of claim 9, wherein a pressure in the pressing step is from 100 kg f/cm² to 700 kg f/cm².

16. The method for producing graphene of claim 9, wherein the carbon material is pressed for from 1 second to 100 hours.

17. The method for producing graphene of claim 2, wherein the solvent comprising one of deionized water, ethanol, Methylpyrrolidone (NMP) and isopropyl alcohol.

18. The method for producing graphene of claim 9, wherein the ultrasonicating power is from 100 watts (W) to 1500 watts.

19. The method for producing graphene of claim 9, wherein the ultrasonicating time is from 1 second to 100 hours.
